(19) United States
(12) Patent Application Publication
(10) Pub. No.: US 2025/0146478 A1
(43) Pub. Date: May 8, 2025

(54) METHOD AND APPARATUS FOR RECOVERING ENERGY

(71) Applicants: Julian PARKER, Heswall, Merseyside (GB); Andre Dawson KRISTEN, Kelowna (CA)

(72) Inventors: Julian PARKER, Heswall, Merseyside (GB); Andre Dawson KRISTEN, Kelowna (CA)

(21) Appl. No.: 18/835,122

(22) PCT Filed: Jan. 31, 2023
(86) PCT No.: PCT/GB2023/050209

§ 371 Date: Aug. 1, 2024

(30) Foreign Application Priority Data
Feb. 1, 2022 (GB) 2201274.4

(51) Int. Cl. F03G 4/02; E21B 41/00; E21B 43/16; E21B 43/243; F03G 4/00

(52) U.S. Cl. CPC F03G 4/02; E21B 41/0085; E21B 43/168; E21B 43/243; F03G 4/001

(57) ABSTRACT

A well 1 is drilled or exists that passes through the earth's surface 2 and underlying rocks 3 to connect with a subterranean hydrocarbon reservoir 4 that contains hydrocarbons 5 and commonly brine 6 (which can include formation, interstitial, connate and injected water). Well 1, (there may be a plurality of well 1's) allows the contents of reservoir 4, either hydrocarbons 5 or brine 6, to flow to the surface.

### FIELD

The present invention relates to methods and apparatus for recovering energy. In particular, the present invention relates to methods and apparatus for recovering energy from fluid and gaseous hydrocarbon deposits. Such deposits can be found worldwide in a variety of geological contexts. Such hydrocarbon deposits accumulate within porous geological structures called reservoirs from which the locally concentrated fluids and gases can be extracted via one or more well holes drilled so as to connect the surface to the reservoir. The reservoir infrastructure is engineered during the operational life to produce as much of the hydrocarbons present as possible before the deposit becomes uneconomical, after which they are decommissioned with unrecovered hydrocarbons left in situ.

### BACKGROUND

Hydrocarbons are produced from hydrocarbon reservoirs via production wells which penetrate into the reservoir and rely initially on the ambient pressure of the reservoir to deliver the hydrocarbon to the surface. With continued extraction of hydrocarbons the reservoir pressure can diminish and production flow can be affected. This will eventually impact on the economical viability of the reservoir as flow can diminish to levels under the economic threshold of operation. Another feature of high volume production, specifically from an oil reservoir, is a localised drop in pressure around the production well which can cause drawing up of the water-oil boundary or draw down of the gas-oil boundary, which is commonly referred to as coning, and can result in suppressed flow or the incorrect fluid/gas reaching the production well Head.

Conventionally a drop in the reservoir pressure is addressed by artificially increasing pressure within the reservoir. This can be achieved by injecting fluid, vapour, gases or liquefied gases into the reservoir at a distance from the production areas of the reservoir, this drives hydrocarbon towards the production area and raises the internal pressure. Another method, is to combust hydrocarbons in place at a calculated distance from the production well, combustion products increase pressure within the reservoir and combustion temperatures can mobilise more viscous crude oil. Any of these methods when properly applied can increase the ambient pressure of the reservoir and consequently drive hydrocarbon towards the production wells or increase the production flow by increasing the pressure within the reservoir. Additionally, increasing reservoir pressure above natural limits can mobilise more oil than would have been produced by relying on the original bottom-hole pressure alone.

The Hydrocarbon production industry abandons production from many reservoirs because either:
The hydrocarbon production potential drops below a given economic threshold.
The well becomes “dry” or becomes limited in its hydrocarbon production potential.
The well becomes water flooded or partially flooded by formation, interstitial, connate, naturally permeating or artificially introduced injection water.
Production pressure drops below a set threshold and methods to increase bottom hole pressure are not deemed economically viable.
Artificial mobilisation of viscous crude by raising reservoir temperatures, such as by steam injection or fire storming, becomes ineffective or uneconomical.

At the point of abandoning a reservoir, large volumes of hydrocarbon will remain in situ and be unrecovered. Hydrocarbon reservoirs at any stage in their life represent a large potential energy resource in the ground. It is therefore advantageous to develop methods to retrieve as much energy as possible from hydrocarbon reservoirs, especially in hydrocarbon reservoirs that can never be truly drained of hydrocarbons, which is the case for all hydrocarbon reservoirs.

### SUMMARY

In accordance with a first aspect of the present invention there is provided a process for recovering energy from a subterranean hydrocarbon reservoir comprising hydrocarbons, said reservoir being in fluid communication with energy conversion means via a first conduit, wherein the process comprises:
delivering an oxidant to the reservoir thereby elevating the ambient pressure and/or temperature within the reservoir resulting in displacement of at least a portion of the contents of the reservoir to deliver at least a portion of the contents at elevated pressure and/or temperature to the energy conversion means via the first conduit.

The present invention provides a method and system to utilize the energy potential of hydrocarbon reservoirs and create work at the surface. In it's simplest form the process may utilise the hydrocarbon and/or brine within the reservoir as a thermal energy source at the ambient temperature of the reservoir. Which due to earth natural thermal gradient is higher than temperatures at the surface.

This may be achieved by elevating and therefore pressure of the reservoir contents by inducing controlled burning of the hydrocarbon element of the reservoir contents through the introduction of oxidants via wells drilled into the reservoir. Wells drilled into the reservoir may then connect the surface to the reservoir contents and fluids and gases from the reservoir, upon reaching the surface, may be utilized to create work from their temperature and pressure. This work in turn can be used to produce electricity without releasing carbon dioxide (CO₂). The resultant electricity may then be used to power separators for all the different products and pumps to send CO₂ into sequestration reservoirs and oxidants down the controlled burn wells. In a late life reservoir, all the well infrastructure would already be in place from the conventional hydrocarbon recovery process previously applied to the reservoir. In addition, electricity may also be used in the electrolysis of water to generate oxygen and hydrogen. The oxygen generated in this process may then be injected into the reservoir at a distance from the production well to allow for further oxidation of the hydrocarbon (and resultant coke) in controlled burns which raise the temperature of the reservoir and the fluids within the reservoir, which may be produced to extract additional work due to the raised subsurface temperature. The hydrogen generated in this process can be used locally as a clean burning fuel, traded as a commodity, or used in the synthesis of ammonia. In instances where the production facility is not connected to an electricity grid, hydrogen or ammonia would be the preferred methods of moving the recovered energy, with the later able to flow along hydrocarbon pipelines with any hydrocarbons recovered from the reservoir, alternatively the electricity can be used to process or manufacture commodities on site.

The energy conversion means may be located at the surface.

The energy conversion means may comprise any one or more of the group comprising: Centrifugal compressors, Rotary screws, Steam engines, Turboexpanders, Reciprocating expanders, Rotary expanders, Marine Diesel Engines, Geothermal Engines, Axial Expanders, Steam Turbines, Heat Engines, Rotary Engines, Reciprocating Engines and/or Piston Engines.

Advantageously, the energy conversion means may comprise a turboexpander.

In accordance with a further aspect of the present invention there is provided a system for recovering energy from a subterranean hydrocarbon reservoir comprising hydrocarbons, said reservoir being in fluid communication with energy conversion means via a first conduit, wherein the system further comprises means for delivering an oxidant to the reservoir thereby elevating the ambient pressure and/or temperature within the reservoir resulting in displacement of at least a portion of the contents of the reservoir to deliver at least a portion of the contents at elevated pressure and/or temperature to the energy conversion means via the first conduit.

The process and/or system may transform expansion of hot high pressure phases into rotary work to drive generators (and/or pumps) and/or can harvest heat via a heat exchanger and then flash lower temperature fluids in a closed circuit to achieve the same effect.

The temperature of the fluid may have a temperature greater than 140° C. Advantageously, the temperature may be 140-600° C., more advantageously 400-600° C. The temperature may be that of the fluid within the system.

The pressure of the fluid may be at least 100 bar, advantageously at least 200 bar, more advantageously 206 bar, even more advantageously up to 400 bar. In an embodiment the pressure of the fluid is 300-400 bar. The pressure may be that of the fluid within the system.

The present invention will now be described, by way of example only, with reference to the accompanying figures, in which:

### BRIEF DESCRIPTION OF THE FIGURES

FIG. 1 is a diagrammatic vertical section through a reservoir in the earth with surface processes shown in accordance with present invention;

FIG. 2 is a diagrammatic vertical section through a reservoir in the earth with additional surface processes shown in accordance with present invention; and

FIG. 3 is a diagrammatic vertical section through a reservoir in the earth with additional surface processes shown in accordance with present invention.

### DETAILED DESCRIPTION

This invention in its basic form comprises of a well drilled into a hydrocarbon reservoir which in turn is connected to an electricity generation unit that uses the expansion of the gas or fluids flowing from the reservoir to mechanically produce electricity and/or uses the heat of the gas or fluids flowing from the reservoir to produce mechanical energy via the transfer of heat into another liquid or gas via a heat exchanger.

Referring to FIG. 1, which is a schematic representation, in a preferred form of the invention a well 1 is drilled or exists that passes through the earth's surface 2 and underlying rocks 3 to connect with a subterranean hydrocarbon reservoir 4 that contains hydrocarbons 5 and commonly brine 6 (which can include formation, interstitial, connate and injected water). Well 1, (there may be a plurality of well 1's) allows the contents of reservoir 4, either hydrocarbons 5 or brine 6, to flow to the surface. In this example, well 1, as the hydrocarbon flow drops, is allowed to produce predominantly brine 6, which is passed through an Electricity Generation Unit 7, that mechanically converts the expansion of the brine 6 into electricity 8. Conventional production equipment and devices, such as would be expected in any hydrocarbon production facility, would also be present but are not included in these descriptions or drawing for clarity, it should therefore be assumed that these elements are present as required. In an alternative variation (not illustrated) hydrocarbon 5 or brine 6 passing up well 1 travels through a heat exchange unit that heats a separate liquid that expands to drive electricity generation unit 7.

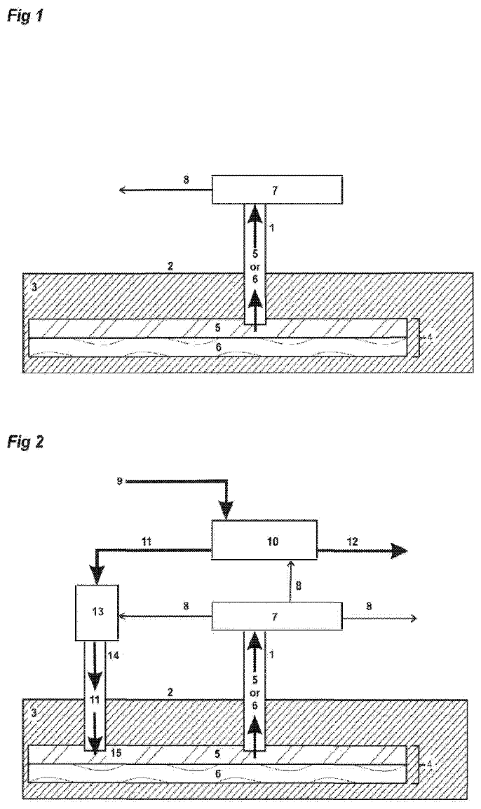

Referring to FIG. 2, which is a schematic representation, electricity 8 as described in FIG. 1, can also be used to split water 9 in Electrolysis Plant 10, this process produces oxygen 11 and hydrogen 12. The water 9 used in Electrolysis Plant 10 may have been derived from brine 6 and purified with the assistance of electricity 8 (not illustrated). Oxygen 11 is then passed to pump 13, and enters hydrocarbon reservoir 4 via well 14, (a plurality of pumps 13 and wells 14 may be used). Oxygen 11, once introduced to hydrocarbon reservoir 4, provides the oxidant to allow the controlled ignition and combustion of hydrocarbon 5 (and resultant coke) insitu, which heats closely located hydrocarbon 5, produces hot carbon dioxide 15 and other combustion products, and elevates the temperature of brine 6. Gases and fluids including hydrocarbon 5, brine 6 and carbon dioxide 15, produced from well 1, is further used to create work and produce electricity via electricity generation unit 7. It may be the case that brine 6 initially does not contain enough heat to create useable work at the surface and in this situation conventional firestorm and controlled burn techniques within reservoir 4 will be required to elevate well 1's production fluid temperature to the point where electricity generation unit 7 can be used effectively to produce electricity 8 and the process shown in FIG. 1 and FIG. 2 becomes self sustaining. Hydrogen 12 produced by Electrolysis plant 10 can be traded as a commodity, burnt locally for CO2 free electricity production or further converted to new products.

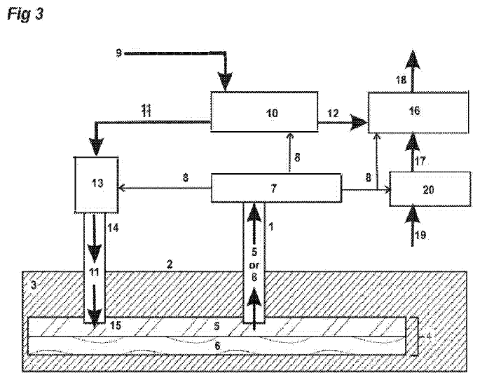

Referring to FIG. 3, which is a schematic representation, electricity 8 used to split water 9 in Electrolysis Plant 10, produces oxygen 11 and hydrogen 12. Oxygen 11 is dealt with and used as shown in FIG. 2, while Hydrogen 12 is passed to Ammonia Synthesis Plant 16 where it is combined with nitrogen 17 to produce anhydrous Ammonia 18. Nitrogen 17 is captured from atmospheric air 19 in Nitrogen Capture Plant 20. Both Ammonia Synthesis Plant 16 and Nitrogen Capture Plant 20 can be powered using electricity 8. Ammonia 18 produced in Ammonia Synthesis Plant 16 can be used locally, transformed into additional products locally, mixed with cleaned hydrocarbon 5 to be transported away from the production site for later separation, or moved separately for trading as a commodity.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the scope of the disclosed innovations should be determined only by the broadest interpretation of the appended claims so as to encompass all such modifications, changes, and omissions. In addition, the order or sequence of any process or method steps may be varied or re-sequenced according to alternative embodiments.

1-20. (canceled)

21. A process for recovering energy from a subterranean hydrocarbon reservoir comprising hydrocarbons, said reservoir being in fluid communication with energy conversion means via a first conduit, wherein the process comprises:
delivering an oxidant to the reservoir thereby elevating the ambient pressure and/or temperature within the reservoir resulting in displacement of at least a portion of the contents of the reservoir to deliver at least a portion of the contents at elevated pressure and/or temperature to the energy conversion means via the first conduit.

22. The process as claimed in claim 21 wherein the energy conversion means is an electricity generating means.

23. The process as claimed in claim 22 wherein the electricity generating means comprises one or more engine capable of converting energy contained within a fluid into mechanical work.

24. The process as claimed in claim 21, wherein the conduit is a well bore.

25. The process as claimed in claim 21, further comprising a second conduit for delivering the oxidant.

26. The process as claimed in claim 21, wherein the oxidant is selected from the group comprising: oxygen and/or other oxidants.

27. The process as claimed in claim 26, further comprising downstream means for electrolysis of water to generate oxygen and hydrogen.

28. The process as claimed in claim 27, further comprising downstream means for delivering the oxygen via a second conduit to the reservoir to facilitate oxidation.

29. The process as claimed in claim 27, further comprising downstream means for generating ammonia to which the generated hydrogen is conveyed to react with nitrogen to generate ammonia.

30. The process as claimed in claim 21, wherein the reservoir also comprises brine.

31. A system for recovering energy from a subterranean hydrocarbon reservoir comprising hydrocarbons, said reservoir being in fluid communication with energy conversion means via a first conduit, wherein the system further comprises means for delivering an oxidant to the reservoir thereby elevating the ambient pressure and/or temperature within the reservoir resulting in displacement of at least a portion of the contents of the reservoir to deliver at least a portion of the contents at elevated pressure and/or temperature to the energy conversion means via the first conduit.

32. The system as claimed in claim 31, wherein the energy conversion means is an electricity generating means.

33. The system as claimed in claim 32, wherein the electricity generating means comprises one or more engine capable of converting energy contained within a fluid into mechanical work.

34. The system as claimed in claim 31, wherein the conduit is a well bore.

35. The system as claimed in claim 31, further comprising a second conduit for delivering the oxidant.

36. The system as claimed in claim 31, wherein the oxidant is selected from the group comprising oxygen and/or other oxidants.

37. The system as claimed in claim 31, further comprising downstream means for electrolysis of water to generate oxygen and hydrogen.

38. The system as claimed in claim 31, further comprising downstream means for delivering the oxygen via a second conduit to the reservoir to facilitate oxidation

39. The system as claimed in claim 31, further comprising downstream means for generating ammonia to which the generated hydrogen is conveyed to react with nitrogen to generate ammonia.

40. The system as claimed in claim 31, wherein the reservoir also comprises brine.
